(19) United States
(12) Patent Application Publication
(10) Pub. No.: US 2015/0269195 A1
(43) Pub. Date: Sep. 24, 2015

(54) MODEL UPDATING APPARATUS AND METHOD

(71) Applicant: KABUSHIKI KAISHA TOSHIBA, Minato-ku (JP)

(72) Inventor: Hideyuki AISU, Kawasaki (JP)

(73) Assignee: KABUSHIKI KAISHA TOSHIBA, Minato-ku (JP)

(21) Appl. No.: 14/659,814

(22) Filed: Mar. 17, 2015

(30) Foreign Application Priority Data
Mar. 20, 2014 (JP) 2014-058879

(51) Int. Cl. G06F 17/30; G06N 99/00

(52) U.S. Cl. CPC G06F 17/30294; G06F 17/30563; G06N 99/005

(57) ABSTRACT

In one embodiment, a model updating apparatus includes a determiner, a selector, an obtainer, an updater. The determiner determines labels to be provided to each of data sets, using two or more models. Each of the data sets include at least one measured value measured by a sensor and a measurement target area of the sensor. The models are functions of the measured values. The selector selects a check target data set from the data sets, based on two or more labels determined by using the two or more models, respectively. The obtainer obtains a label provided by a user to the check target data set selected by the selector. The updater updates the models based on the check target data set and the label obtained by the obtainer.

### CROSS REFERENCE TO RELATED APPLICATION(S)

This application is based upon and claims the benefit of priority from the prior Japanese Patent Application No. 2014-058879, filed on Mar. 20, 2014, the entire contents of which are incorporated herein by reference.

### FIELD

Embodiments described herein relate generally to a model updating apparatus and method.

### BACKGROUND

In recent years, attention has been focused on a so-called remote monitoring system that remotely provides various types of services, such as the monitoring, control, and diagnosis of a facility, via the Internet. In the remote monitoring system, data on sensors provided in a facility is obtained via the Internet and services are provided based on the obtained data. Thus, mathematical models for objects may be constructed and used for control and diagnosis. In addition, as a means of generating such mathematical models, machine learning may be used.

For example, in the case of a remote monitoring system that manages energy, an estimated model for a user's current state such as “sleeping” or “away” is constructed by machine learning for an inputted power waveform, and control according to the result of estimation, such as a transition to power saving mode when the label “away” is provided, can be performed. In addition, in demand response where power saving control of a device in a building or at home is remotely performed, how much discomfort a user of the building has felt as the result of power suppression is estimated, which can be reflected in improvement in control method.

However, in the remote monitoring system, when a label (a classification category of an output value) to be provided to data indicates a human sense (hot, cold, etc.), in order to appropriately update a determination model for providing a label to data, a learner needs to obtain sets of data and a label from users, which requires questionnaires or reexperiments on the facility side. In the remote monitoring system, since there is a case in which there is no administrator stationed on the facility side, it is difficult to obtain sets of data and a label by questionnaires or reexperiments to update the determination model.

For one machine learning technique for improving learning efficiency, there is known a technique called active learning where a learner (computer) actively selects data required for learning. For example, the active learning is receiving attention as a technique suitable for screening, etc., in drug discovery. In the active learning, the learner (computer) requests a user (human) to provide a label to inputted data.

### BRIEF DESCRIPTION OF THE DRAWINGS

FIG. 1 is a block diagram showing a functional configuration of a model updating apparatus according to an embodiment;

FIG. 2 is a diagram showing an example of sensor information;

FIG. 3 is a diagram showing an example of user information;

FIG. 4 is a diagram showing an example of data sets;

FIG. 5 is a diagram showing an example of data sets provided with labels;

FIG. 6 is a block diagram showing a configuration of a computer apparatus; and

FIG. 7 is a flowchart showing a determination model update process performed by the model updating apparatus of FIG. 1.

### DETAILED DESCRIPTION

Embodiments will now be explained with reference to the accompanying drawings. The present invention is not limited to the embodiments.

In one embodiment, a model updating apparatus includes a determiner, a selector, an obtainer, an updater. The determiner determines labels to be provided to each of data sets, using two or more models. Each of the data sets include at least one measured value measured by a sensor and a measurement target area of the sensor. The models are functions of the measured values. The selector selects a check target data set from the data sets, based on two or more labels determined by using the two or more models, respectively. The obtainer obtains a label provided by a user to the check target data set selected by the selector. The updater updates the models based on the check target data set and the label obtained by the obtainer.

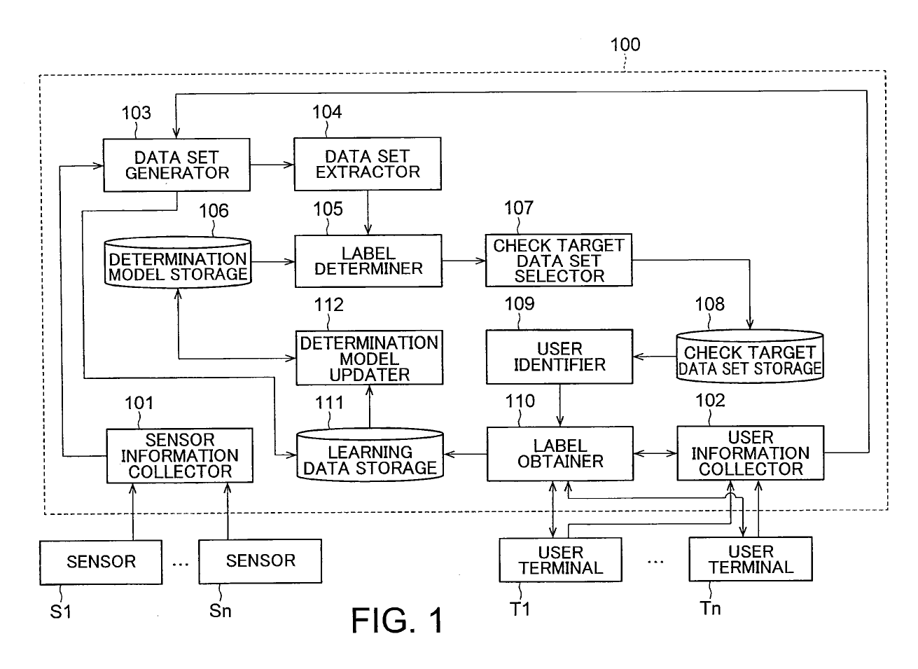

Embodiments of a model updating apparatus and a model updating method will be described below with reference to the drawings. FIG. 1 is a block diagram showing a functional configuration of a model updating apparatus 100 according to the present embodiment.

The model updating apparatus 100 of FIG. 1 includes a sensor information collector 101, a user information collector 102, a data set generator 103, a data set extractor 104, a label determiner 105, a determination model storage 106, a check target data set selector 107, a check target data set storage 108, a user identifier 109, a label obtainer 110, a learning data storage 111, and a determination model updater 112.

The sensor information collector 101 (hereinafter, referred to as the “collector 101”) performs wireless or wired communication with a plurality of sensors Sn (n=1, 2, . . . ) provided in an apartment complex, a building, a plant, and the like, to collect sensor information of each sensor Sn at a predetermined time interval.

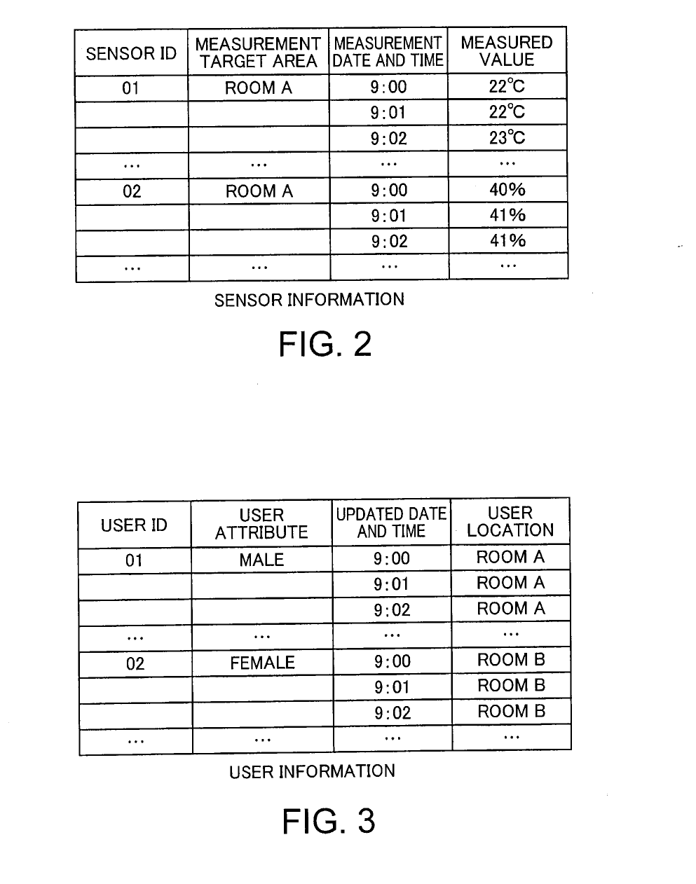

FIG. 2 is a diagram showing an example of sensor information. In FIG. 2, sensor information is collected at one-minute intervals, but is not limited thereto. As shown in FIG. 2, each of sensor information includes a sensor ID of a sensor Sn, a measurement target area, measurement date and time, a measured value (data), etc., but is not limited thereto.

The measurement target area refers to a space which is predetermined as a target of measurement performed by the sensor Sn. The measurement target area is set for each room or each passage, for example. When sensor information obtained from a sensor Sn does not include a measurement target area, the collector 101 may set the measurement target area of the sensor Sn based on a sensor ID, an instrumentation diagram, etc., and add the measurement target area to the sensor information.

The user information collector 102 (hereinafter, referred to as the “collector 102”) performs wireless or wired communication with user terminals Tn (n=1, 2, . . . ) owned by users, to collect user information of the users at a predetermined time interval. The user as used herein refers to a user who is pre-registered in the model updating apparatus 100 among the users of institutions or facilities such as an apartment complex, a building, and a plant.

The user terminal Tn is any terminal that can communicate with the collector 102. As the user terminal Tn, a mobile phone, a smartphone, a PC, a dedicated terminal, and the like, can be used. Application software that allows predetermined information to be communicated between the user and the model updating apparatus 100 is installed on the user terminal Tn.

FIG. 3 is a diagram showing an example of user information. In FIG. 3, user information is collected at one-minute intervals, but is not limited thereto. As shown in FIG. 3, each of user information includes profile information of a user who is pre-registered on a user terminal Tn, context information which is updated by the user terminal Tn whenever necessary, etc. The profile information includes a user ID and a user attribute (gender, age, occupation, etc.). The context information includes user (user terminal Tn) location information, location information updated date and time, etc. Note that there may be a case in which a user terminal Tn is fixedly placed in a specific location and an indefinite number of users perform an input to the user terminal Tn.

The data set generator 103 (hereinafter, referred to as the “generator 103”) generates a data set (vector data) including at least one measured value which is measured by a sensor Sn and a measurement target area of the sensor Sn, based on the sensor information obtained from the collector 101.

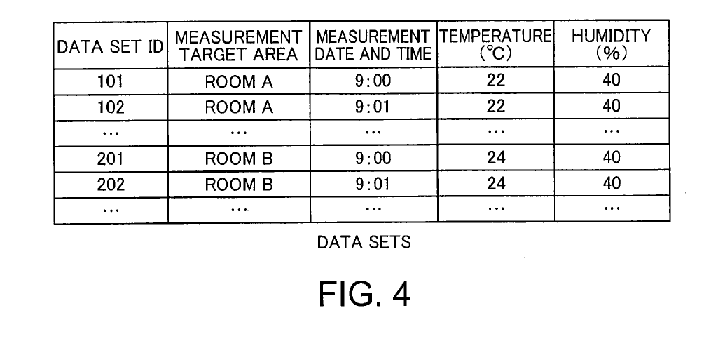

FIG. 4 is a diagram showing an example of data sets. As shown in FIG. 4, data sets are generated on a measurement date and time basis and a measurement target area basis. For example, a data set 101 of FIG. 4 is a data set for 9:00 at room A. Each data set may include a plurality of measured values having the same measurement date and time and the same measurement target area.

In addition, the generator 103 may generate a data set including user information. In this case, a data set including measurement data and time X and a measurement target area Y includes user information of users present in the measurement target area Y at the measurement date and time X. Whether the user has been in the measurement target area Y at the measurement date and time X can be determined based on location information and location information updated date and time which are included in the user information.

When the generator 103 can obtain sensor information and user information from an external apparatus, it is also possible to employ a configuration not including the collector 101 and the collector 102.

The data set extractor 104 (hereinafter, referred to as the “extractor 104”) extracts data sets to be subjected to a label determination process by the label determiner 105 from among a plurality of data sets generated by the generator 103. A method of extracting data sets by the extractor 104 may be any. For example, a method may be considered in which a group of data sets similar to each other is formed using cross-correlation, and one or a plurality of data sets are extracted from among the formed group of data sets. By the extractor 104 extracting data sets to be subjected to a label determination process, the time required for a label determination process by the label determiner 105 and subsequent processes can be reduced.

The label determiner 105 (hereinafter, referred to as the “determiner 105”) determines labels to be provided to the data sets extracted by the extractor 104, using at least two determination models for providing labels. The labels as used herein refer to classification categories which are outputted for a data set inputted to the determination models. In the present embodiment, a data set is provided with labels indicating human senses such as “hot”, “comfortable”, and “cold”. However, it is possible to handle various types of labels, e.g., labels indicating user's activities such as “sleeping” and “away” or labels indicating the states of a device such as “out of order” and “normal”, and thus, there are no limitations on the types of labels to be handled.

In addition, the determination model is a function that outputs a label for an inputted data set. For the function, it is possible to use a function represented by a formula having variables for which measured values included in a data set are substituted and a predetermined parameter, or a function where the relationship between measured values and a label is represented in an IF-THEN rule format. Such a determination model includes, for example, a rule-set model, a logit model, a multiple regression model, a neural network model, and a classification tree model.

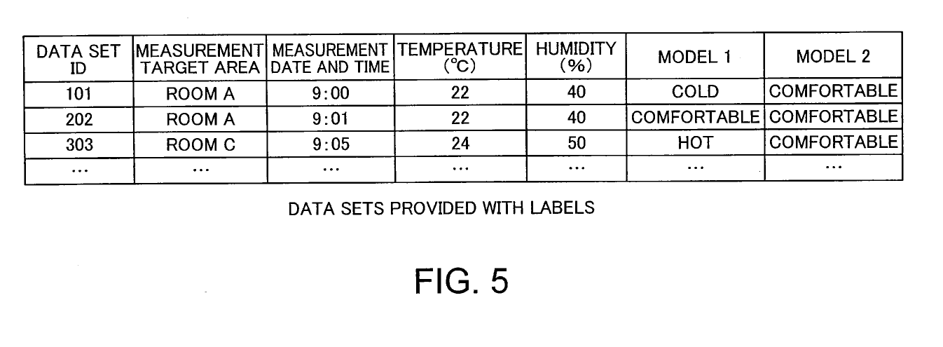

FIG. 5 is a diagram showing an example of data sets provided with labels. As shown in FIG. 5, each data set is provided with a plurality of labels which are determined using a plurality of determination models, respectively. The determination models output the same type of label.

The determination model storage 106 (hereinafter, referred to as the “storage 106”) stores a plurality of determination models used for a label determination process performed by the determiner 105. When a determination model is represented by a formula, a predetermined parameter used for the formula is stored in the storage 106. Upon a label determination process, the determiner 105 obtains desired determination models from the storage 106.

The check target data set selector 107 (hereinafter, referred to as the “selector 107”) selects check target data sets from among the data sets extracted by the extractor 104, based on the results of the determination made by the determiner 105. The check target data set refers to a data set which is difficult to perform a label determination by determination models. The label obtainer 110 allows users to provide labels of the check target data sets. A method of selecting check target data sets will be described later.

The check target data set storage 108 (hereinafter, referred to as the “storage 108”) stores the check target data sets selected by the selector 107.

The user identifier 109 (hereinafter, referred to as the “identifier 109”) identifies users (user IDs) present in the measurement target areas of the check target data sets stored in the storage 108, by referring to the latest user information. The identifier 109 may obtain the latest user information from the collector 102. Alternatively, when a data set generated by the generator 103 includes user information, the latest data set may be obtained from the generator 103. A method of identifying users by the identifier 109 will be described later.

The label obtainer 110 (hereinafter, referred to as the “obtainer 110”) presents, through the user terminals Tn, candidates for labels to the users identified by the identifier 109 to request to provide labels. The request is performed using, for example, dedicated application software installed on the user terminals Tn or email software. The users provide labels from among the presented candidates for labels, according to their senses.

A label provided by a user is a label provided to a data set at the time when the user has provided the label. Therefore, the data set to which the user has provided the label does not always match the check target data set. In addition, when a user who is present in the measurement target area at the time when he/she is requested to provide a label has provided a label after moving out of the measurement target area, the obtainer 110 may remove the label. For example, the obtainer 110 can determine whether the label is provided outside the measurement target area, based on user location information obtained at the time when the label is provided by the user, and remove the label. The obtainer 110 generates learning data, based on the labels obtained from the users and the data collected by the sensor information collector 101.

The learning data is data in which a data set obtained at the time when users present in a measurement target area have provided labels is combined with the labels provided to the data set by the users. The learning data storage 111 may generate the data set based on sensor information from the sensor information collector 101 and user information, or may obtain the data set from the generator 103.

The learning data storage 111 (hereinafter, referred to as the “storage 111”) stores new learning data generated by the obtainer 110, so as to add the new learning data to originally stored learning data. In order to eliminate contradictory leaning data so that the number of learning data does not exceed a certain number, upon addition of new learning data some learning data having old addition times may be deleted or old learning data whose elements other than labels are similar to those of learning data to be added may be deleted.

The determination model updater 112 (hereinafter, referred to as the “updater 112”) updates the determination models stored in the storage 106, based on the learning data stored in the storage 111. Specifically, the updater 112 updates a determination model by adjusting a parameter of the determination model such that labels included in learning data are outputted for a data set included in the learning data. An update to a determination model by the updater 112 corresponds to so-called supervised learning; however, the learning method depends on the type of determination model used and thus is not particularly limited.

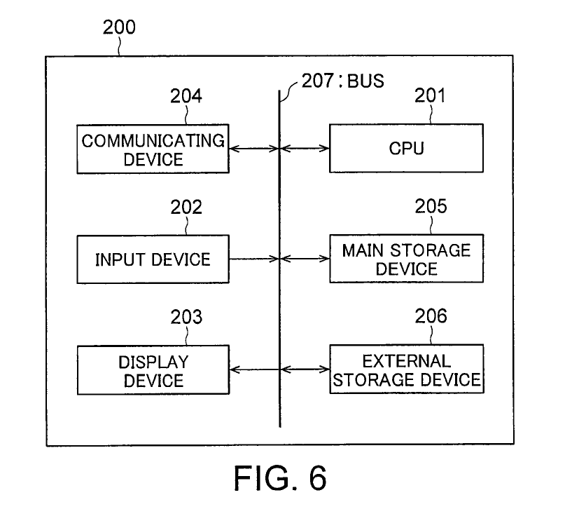

The model updating apparatus 100 described above can be implemented by using a computer apparatus 200 as basic hardware. FIG. 6 is a block diagram showing a configuration of the computer apparatus 200. As shown in FIG. 6, the computer apparatus 200 includes a CPU 201, an input device 202, a display device 203, a communicating device 204, a main storage device 205, and an external storage device 206, and they are connected to each other by a bus 207.

The input device 202 is, for example, input devices such as a keyboard and a mouse, and outputs to the CPU 201 operation signals generated by operations of the input devices. The display device 203 is, for example, a display such as an LCD (Liquid Crystal Display) or a CRT (Cathode Ray Tube). The communicating device 204 has a wireless or wired communication means and performs communication by a predetermined communication scheme. The functions of the collector 101 and the collector 102 are implemented by the communicating device 204.

The external storage device 206 is, for example, a storage medium such as a hard disk, a memory apparatus, a CD-R, a CD-RW, a DVD-RAM, or a DVD-R. The external storage device 206 stores a program for allowing the CPU 201 to perform the processes of the model updating apparatus 100. The storage 106, the storage 108, and the storage 111 are implemented by the external storage device 206.

The main storage device 205 expands the program stored in the external storage device 206 under the control of the CPU 201 and stores data required when executing the program, data generated by the execution of the program, etc. By the CPU 201 executing the program, the functional configurations of the generator 103, the extractor 104, the determiner 105, the selector 107, the identifier 109, the obtainer 110, and the updater 112 are implemented. The main storage device 205 is, for example, any memory such as volatile memory or nonvolatile memory.

The above-described program may be pre-installed on the computer apparatus 200 or may be stored in a storage medium such as a CD-ROM and then installed on the computer apparatus 200 as appropriate. Note that it is also possible to employ a configuration not including the input device 202, the display device 203, and the communicating device 204.

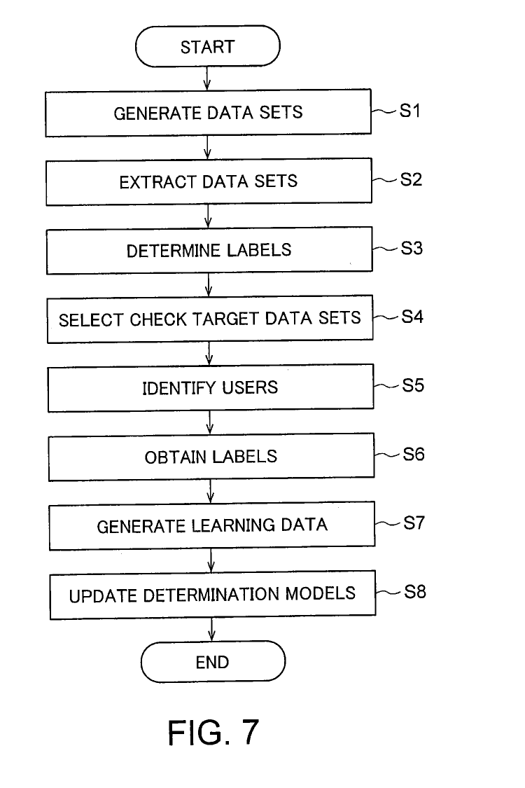

Next, a determination model update process performed by the model updating apparatus according to the present embodiment will be described with reference to FIG. 7. As shown in FIG. 7, when a determination model update process starts, first, the generator 103 obtains sensor information collected by the collector 101 and generates a plurality of data sets (step S1).

The extractor 104 obtains the plurality of data sets generated by the generator 103 and extracts data sets to be subjected to a label determination process from among the plurality of data sets (step S2). The extractor 104, for example, forms a group of data sets similar to each other, using cross-correlation and extracts one or a plurality of data sets from among the formed group of data sets.

The determiner 105 obtains the data sets extracted by the extractor 104 and obtains a plurality of determination models stored in the storage 106, to determine a plurality of labels to be provided to each data set (step S3).

The selector 107 selects check target data sets, based on the labels of each data set determined by the determiner 105 (step S4). When, as shown in FIG. 5, each data set is provided with a plurality of labels, i.e., when the determiner 105 determines labels to be provided to each data set using a plurality of determination models, the selector 107 compares the plurality of labels provided to each data set to select a data set whose labels vary from each other, as a check target data set.

The data set whose labels vary from each other is a data set which is difficult to uniquely identify a label with the currently used determination models because different labels are provided by the determination models. By selecting such a data set as a check target data set and using the data set to update the determination models, the accuracy of determination by the determination models can be improved.

Specifically, the selector 107 selects a check target data set by comparing the degree of label variation of each data set with a predetermined threshold value. For example, as an index indicating the degree of variation, the number of identical labels can be used. In this case, the selector 107 selects, as a check target data set, a data set where the number of identical labels among a plurality of labels provided to the data set is a predetermined number or the percentage of identical labels among the plurality of labels is less than or equal to a predetermined percentage.

Alternatively, as an index indicating the degree of variation, entropy can be used which is calculated based on the number of determination models used to provide labels to each data set and the labels provided to the data set. The entropy can be computed by the following equation by referring to the query-by-committee method which is one of active learning methods:

$$Entropy P = ( - {\sum }_{y} \frac{V ( y )}{C} log \frac{V ( y )}{C} ) \qquad [ Equation 1 ]$$

In the above-described equation, C is the number of determination models (the number of classifiers) and V(y) is the number of determination models that determine the label to be “label y”. The selector 107 compares the entropy computed in this manner with a predetermined threshold value to select, as check target data sets, a certain number of data sets whose entropy is larger than the threshold value or a certain number of data sets in descending order of their entropy.

Note that, for the check target data set selection criterion, other active learning methods can also be used and thus the selection criterion is not particularly limited. For example, in the case of using a model of a type that outputs the probability P(y|x) of certainty of a label when data x is inputted, such as a logit model, the uncertainty of data determination may be determined by an uncertainty sampling method. In this case, entropy can be computed by the following equation:

$$Entropy P = ( - {\sum }_{y} P ( y \vert x ) log P ( y \vert x ) ) \qquad [ Equation 2 ]$$

The selector 107 may set priorities to the check target data sets, according to the degree of label variation calculated in the above-described manner. When priorities are set, the obtainer 110 requests users to provide labels to the check target data sets with higher priorities on a priority basis. By this, the determination models are updated on a priority basis based on the check target data sets with higher priorities. The selector 107, for example, sets a high priority to a check target data set with a large degree of label variation.

The check target data sets selected by the selector 107 are stored in the storage 108.

The identifier 109 identifies users to be requested to provide labels, at a predetermined time interval or at the timing at which a predetermined number of check target data sets are stored in the storage 108 (step S5). The identifier 109 first selects a check target data set whose users are to be identified, and obtains a set of a measurement target area and sensor information of the selected check target data set. Then, by referring to the latest user information, users present in the obtained measurement target area are identified as users to be requested to provide labels. The identifier 109 performs the above-described process on each check target data set.

When the check target data set includes user information, the identifier 109 can identify, based on the user information, users to be requested to provide labels from among the users present in the measurement target area. For example, the tendency of the attributes of user information included in the check target data set may be identified, and users having attributes that match the tendency may be identified as users to be requested to provide labels. Specifically, when it has been found from the check target data set that there are many women in the measurement target area, female users may be requested to provide labels.

By thus identifying users taking into account user information, labels obtained from the users become closer to the actual situation. Therefore, by updating the determination models using the labels, the accuracy of determination by the determination models can be improved.

In addition, the identifier 109 may perform user identification only when the measured values at the measurement target area are the same as or similar to the measured values in the check target data set. For example, when the check target data set is (room A, temperature 22° C., and humidity 40%), the identifier 109 performs user identification only when the measured values at room A are the same as or similar to (temperature 22° C. and humidity 40%). Whether the measured values are similar or not can be determined by using a similarity range set for each measured value, or cross-correlation.

By thus identifying users taking into account the measured values at the measurement target area, labels for a data set which is the same as or similar to a check target data set can be obtained from the users. Accordingly, the determination models can be efficiently updated.

The obtainer 110 displays, for example, the question “How do you feel?” Press and select any of the buttons ‘hot’, ‘comfortable’, and ‘cold’, on the user terminals Tn of the users identified by the identifier 109, and thereby obtains labels from the users (step S6).

When the obtainer 110 obtains labels from the users, the obtainer 110 generates learning data based on the obtained labels and a data set obtained at the time when the labels are provided (step S7). The learning data generated by the obtainer 110 is stored in the storage 111.

The updater 112 obtains learning data and determination models at a predetermined time interval or at the timing at which a predetermined number of learning data are stored in the storage 111, and updates the determination models using the obtained learning data (step S8). The determination models updated by the updater 112 are stored in the storage 106. Note that the determination model update process of FIG. 7 is a process which is periodically repeated during the operation of the system. In addition, the processes from steps S1 to S4, the processes from steps S5 to S6, and the processes from steps S6 to S7 are processes that can be performed in parallel using data accumulated in the storage 108 and the storage 111, and are not always performed sequentially.

As described above, according to the model updating apparatus 100 and the model updating method according to the present embodiment, labels provided to data sets by users can be remotely obtained through the user terminals Tn. In addition, determination models can be automatically updated using the obtained labels. Therefore, since questionnaires or reexperiments are not required to update the determination models, the accuracy of determination by the determination models can be easily improved. When the model updating apparatus 100 is applied to a remote monitoring system, the quality of services provided by the remote monitoring system can be easily improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A model updating apparatus comprising:
a determiner to determine labels to be provided to each of data sets, using two or more models, each of the data sets including at least one measured value measured by a sensor and a measurement target area of the sensor, and the models being functions of the measured values;
a selector to select a check target data set from the data sets, based on two or more labels determined by using the two or more models, respectively;
an obtainer to obtain a label provided by a user to the check target data set selected by the selector; and
an updater to update the models based on the check target data set and the label obtained by the obtainer.

2. The apparatus according to claim 1, wherein the selector selects the check target data set, based on a degree of variation between the plurality of labels determined by using the plurality of models, respectively.

3. The according to claim 2, wherein the selector uses entropy as an index of the degree of variation, the entropy being calculated based on a number of the plurality of models and the labels determined by using the models, respectively.

4. The apparatus according to claim 1, further comprising an identifier to identify a user present in the measurement target area of the check target data set, wherein
the obtainer obtains a label from the user identified by the identifier.

5. The apparatus according to claim 1, wherein the obtainer obtains a label from the user only when the measured value at the measurement target area is same as or similar to a measured value of the check target data set.

6. The apparatus according to claim 1, wherein the updater updates the models such that a label provided by the user is outputted for a data set obtained at a time when the label is provided by the user.

7. A model updating method comprising:
determining labels to be provided to each of data sets, using two or more models, each of the data sets including at least one measured value measured by a sensor and a measurement target area of the sensor, and the models being functions of the measured values;
selecting a check target data set from the data sets, based on two or more labels determined by the two or more models, respectively;
obtaining a label provided by a user to the selected check target data set; and
updating the models based on the check target data set and the label provided by the user.
